(19) United States
(12) Patent Application Publication
(10) Pub. No.: US 2002/0109776 A1
(43) Pub. Date: Aug. 15, 2002

(54) Method of aligning and mounting hub member on data storage disk

(76) Inventors: Thomas E. Berg, Fort Collins, CO (US); David L. Blankenbeckler, Longmont, CO (US); William W. Dunford, Boulder, CO (US); Robert D. Freeman, Erie, CO (US); Rene D. Kumar Anirudhan, Lafayette, CO (US); Erik J. Zimmer, Denver, CO (US)

Correspondence Address: David E. Steuber, SKJERVEN MORRILL MacPHERSON LLP, 25 Metro Drive, Suite 700, San Jose, CA, 95110-1349, US

(21) Appl. No.: 09/745,399

(22) Filed: Dec. 21, 2000

(51) Int. Cl. H04N 7/18

(52) U.S. Cl. 348/95; 348/94

(57) ABSTRACT

According to the method of this invention, a hub is placed at a machine center of an hub alignment and bonding tool and a data storage disk is placed loosely on the hub in such a way that the disk can be translated with respect to the hub. A curable adhesive is interposed between the hub and the disk. The disk has a data region which includes spiral or circular data tracks. A number of video cameras are focused on an edge of the data region at different locations. The locations of edge recorded in the camera are used to calculate whether the geometric center of the data region is within a predetermined tolerance of the hub center. The respective locations of the center of the data region and the hub center and the distance between the two centers are displayed on a monitor. Using a pair of micrometers which abut the edge of the disk, an operator adjusts the location of the disk until the geometric center of the data region is within the predetermined tolerance of the hub center. The adhesive is then cured, bonding the disk to the hub.

### CROSS-REFERENCE TO RELATED APPLICATIONS

This application is related to Application No. [Attorney Docket No. M-8729 US], filed herewith, entitled “Crimping Tool For Metal Hub Plate”, and Application No. [Attorney Docket No. M-8778-1P US], filed herewith, entitled “Magnetic Hub Assembly For Data Storage Disk”, each of which is incorporated herein by reference in its entirety.

### FIELD OF THE INVENTION

This invention relates to data storage disks, such as optical disks, on which a data region is visible, and in particular to a method of mounting such disks on a hub such that the data tracks are concentric about a center hole of the hub.

### BACKGROUND OF THE INVENTION

Data is stored on data storage disks in the form of spiral or circular data tracks which together form a data region of the disk. The data tracks include a series of marks that represent digital bits and may be formed in a groove or ridge on the disk. As is well known, the data is written to or read from the disk by rotating the disk under a read/write head. The data tracks are not necessarily concentric with respect to the edge of the disk.

To insure a proper read or write operation, the data tracks must be concentric about the center of rotation of the disk to a high degree of accuracy. To obtain this level of concentricity, the disk can be mounted on a hub. The hub has a center hole that defines a rotational axis of the hub when the disk is placed on a spindle of the disk drive. Before the hub is firmly attached to the disk, the position of the hub with respect to the disk can be adjusted so that rotational axis of the hub (the center of the hole) is located at the geometric center of the data tracks.

There is a need for an effective way of attaching the hub to the disk such that the center hole of the hub is properly aligned with the geometric center of the data region.

### SUMMARY OF THE INVENTION

The method of this invention provides a superior way of mounting a hub member on a data storage disk such that the geometric center of a data region (data tracks) of the disk (sometimes referred to herein as the “data center”) is properly aligned with the center of the hub member. Initially, the hub member is placed such that the hub center is coincident with a “machine center”, and the disk is placed on the hub member. A plurality of cameras are positioned such that each of the cameras records a view of a section of an edge of the data region (sometimes referred to as the “data edge”). The location of the data center is then calculated using the locations of the sections of the data edge in the views recorded by the cameras.

In one embodiment the location of the data center is calculated by determining the difference between a current reading of a section of the data edge each of the cameras and a calibration value. The difference for each camera is compared against a predetermined tolerance value.

The method may also include calculating a location of the data center in an XY coordinate system and determining the distance between the data center and the machine center.

The data center and the machine center and the distance therebetween can be displayed on a computer monitor.

The location of the disk is adjusted until the reading of the section of the edge of the data region in the camera is less than the predetermined tolerance, and the disk and hub member are then bonded together. A UV-curable adhesive can be used for this purpose. If there is a data region on the other side of the disk, the other data region may be aligned to a second hub member using the method described above.

The method of this invention can be used with any type of data storage disk on which the data region is capable of optical detection.

The method is preferably performed on a disk centering tool, and the method may include calibrating the disk centering tool. Calibrating the disk centering tool comprises positioning a calibration disk at a machine center and averaging readings obtained by viewing the calibration disk through the cameras at several angular positions of the calibration disk.

### BRIEF DESCRIPTION OF THE DRAWINGS

FIG. 1A is a block diagram of a hub alignment and bonding tool for performing the method of this invention.

FIG. 1B is a perspective view of the hub alignment and bonding tool.

FIG. 2A is a perspective view of the align and cure station of the alignment and bonding tool.

FIG. 2B is a front view of the align and cure station.

FIG. 2C is a close-up view of the align and cure station.

FIG. 2D shows the conical head that is used during the alignment of the first hub member on one side of the disk.

FIG. 2E shows the conical head that is used during the alignment of the second hub member on the opposite side of the disk.

FIG. 2F is a schematic top view of the align and cure station.

FIG. 3 is an illustrative view of the monitor showing the images of data edge that are generated by the cameras.

FIG. 4 is a perspective view of one of the hub members.

FIG. 5A a cross-sectional view showing a disk mounted on a hub.

FIG. 5B is an expanded version of FIG. 5A showing how the first hub member acts as a light pipe during the bonding of the second hub member.

FIG. 5C is a perspective view of the metal hub plate, showing the location of notches used to admit UV light to the hub member.

FIG. 5D is a plan view of the metal hub plate.

FIG. 6 is a flow chart of a process of calibrating the hub alignment and bonding tool.

FIG. 7A and 7B show a flow chart of a process of aligning and mounting a disk on a hub.

FIG. 8A is a view of the monitor during the process of centering a hub.

FIG. 8B is a view of the monitor while the alignment tool is being calibrated to identify a machine center.

### DESCRIPTION OF THE INVENTION

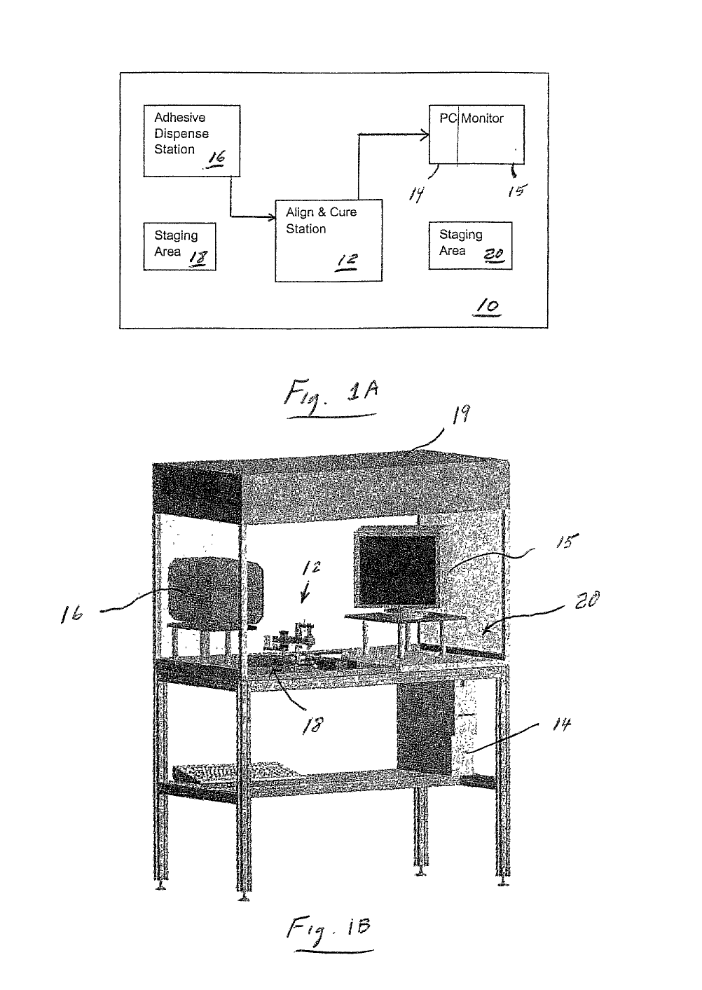

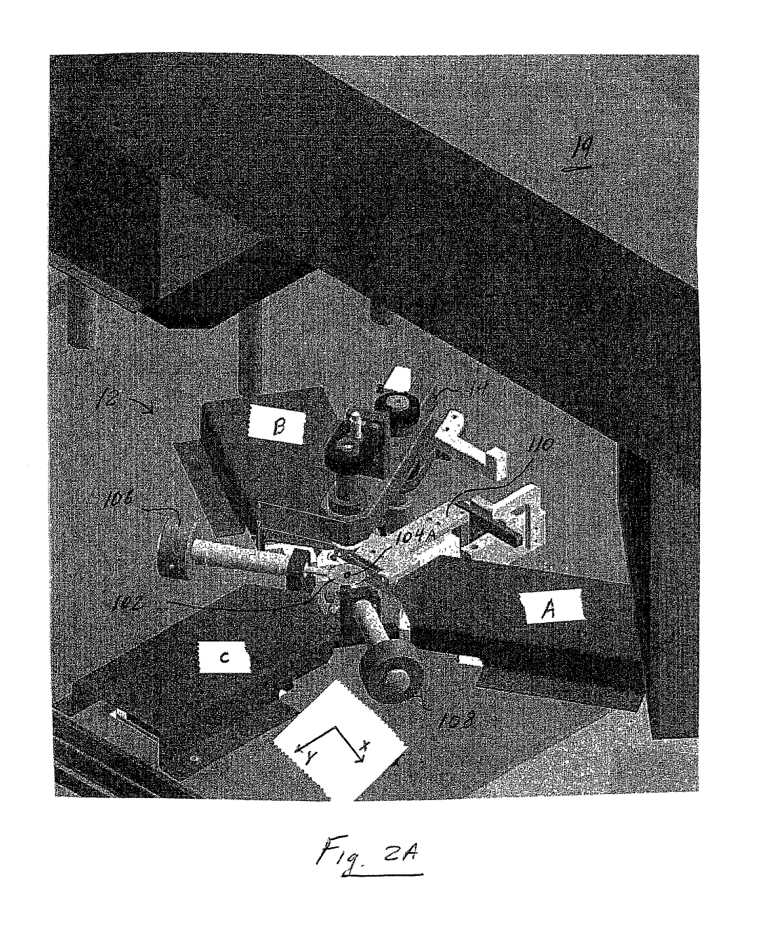

FIG. 1A is a block diagram of a hub alignment and bonding tool 10 for performing the method of this invention. Tool 10 includes an align and cure station 12, a PC 14, a monitor 15 and an adhesive dispense station 16. As described below, signals generated in the align and cure station 12 are delivered to the PC 14. Dispense station 16 is used to dispense an adhesive to align and cure station 12. Staging areas 18 and 20 are also provided to store incoming and outgoing parts.

FIG. 1B is a perspective view of hub alignment and bonding tool 10, showing the align and cure station 12, PC 14, monitor 15, and adhesive dispense station 16. A flow hood 19 is provided over the align and cure station 12, and a flow of air through flow hood 19 prevents debris from settling on the parts being processed. Hood 19 may have HEPA (High Efficiency Particulate Air) filters and a built-in bar type ionizer so as to not disrupt the normal flow of air from the hood. Hood 19 preferably provides a Class 1000 or better clean room environment.

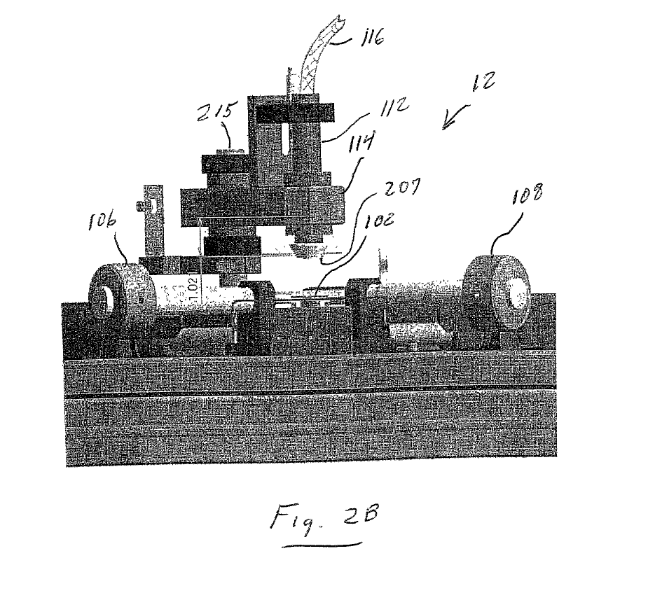

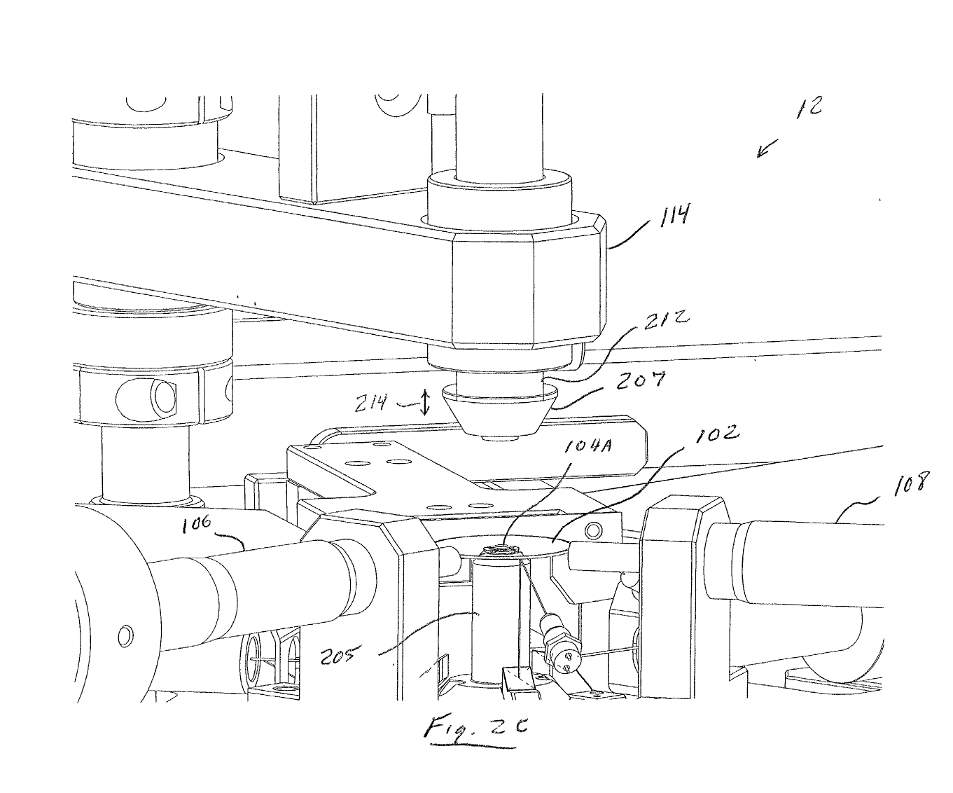

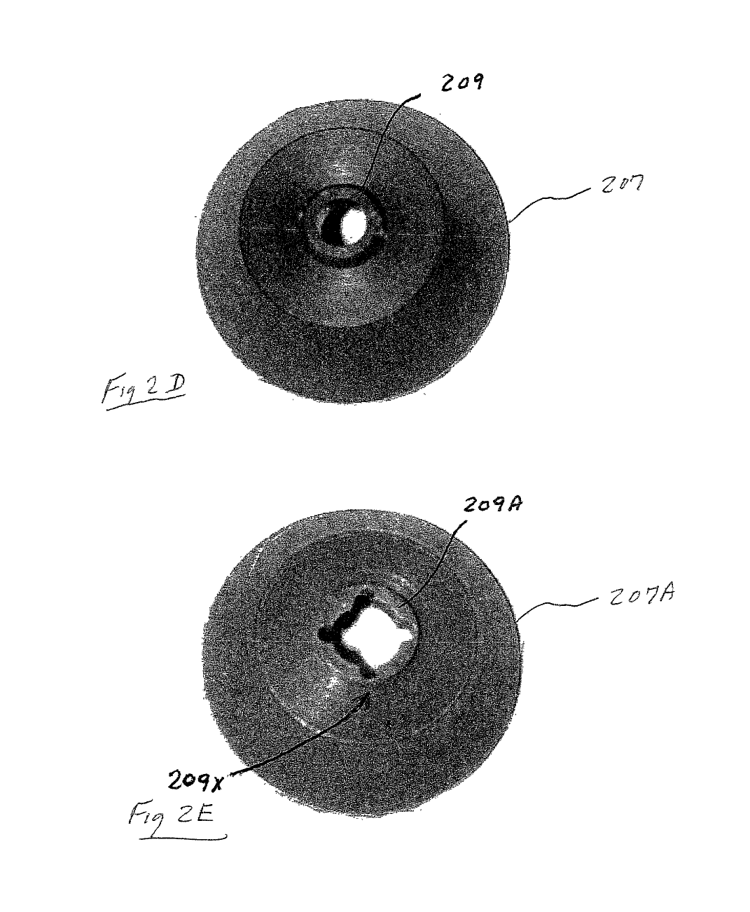

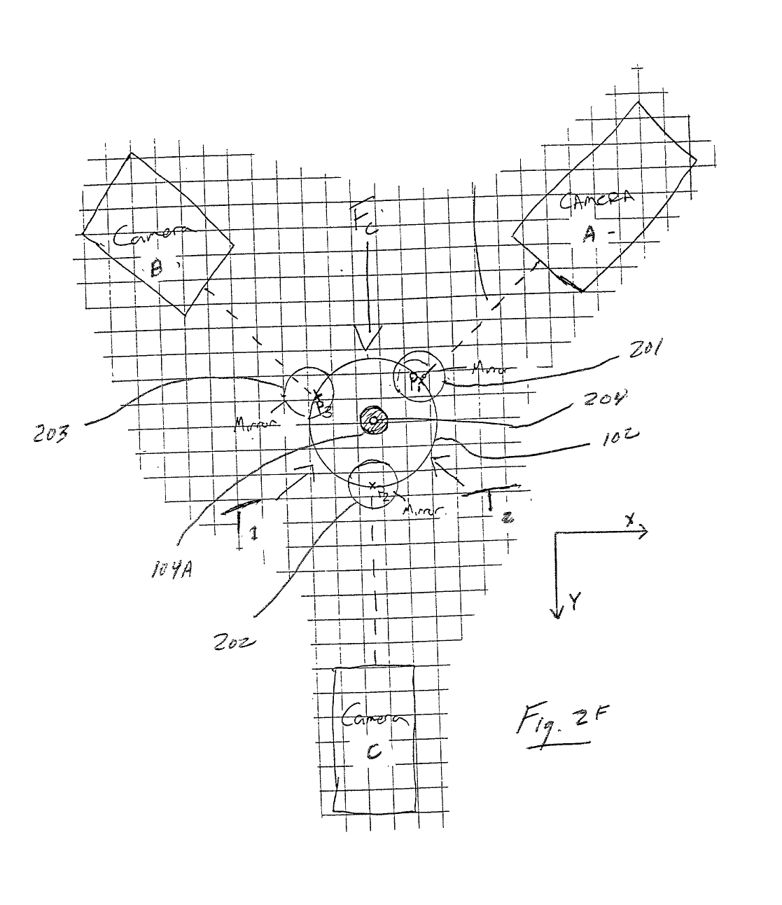

FIGS. 2A and 2B are perspective and front views, respectively, of align and cure station 12. Video cameras A, B and C, which can be the Series 600 SmartImage Sensor unit manufactured by DVT Corporation, are mounted at 120° intervals around a data storage disk 102. (Note that the cameras themselves are not generally visible in FIG. 2A because they are covered by housings.) Output signals from video cameras A, B and C are connected to PC 14. Disk 102 is movably placed on a hub member 104A, which is mounted on a spindle positioned at the center point of station 12. Hub member 104A is free to rotate about the spindle (which is not visible in FIG. 2A). In this embodiment, disk 102 is an optical disk prerecorded on both sides.

Also surrounding disk 102 are micrometers 106 and 108, which are mounted at a 90° angle with respect to each other, and which have movable plungers abutting the edge of disk 102. In this embodiment, micrometers 106 and 108 are positioned symmetrically about camera B. Micrometers 106 and 108 can be obtained from Starrett Co.

Also mounted around disk 102, in a direction opposite to camera C, is a spring stop 110, which abuts an edge of disk 102 and forces disk 102 against the plungers of micrometers 106 and 108. Thus, when the spring stop 110 is pushed forward towards the disk 102, disk 102 is held securely between micrometers 106 and 108 and spring stop 110, and the play in spring stop 110 allows disk 102 to be translated by adjusting micrometers 106 and 108.

Referring still to FIG. 2B, a light pipe 116 is mounted to a fixture 114. The other end of light pipe 116 is connected to a UV source (not shown). Light pipe 116 extends through a tube 112 and fixture 114 to a conical head 207. In FIG. 2B head 207 is shown directly over disk 102, but fixture 114 can be pivoted about a shaft 215 to a holding position away from hub member 104A. The UV source can be switched on and off to expose the hub 104 to ultraviolet light and thus cure the adhesive. Any commercially available UV source can be used, provided that the wavelength of the UV light corresponds to the wavelength required to cure the UV adhesive used. Note that for the sake of clarity light pipe 116 is omitted from FIGS. 1A and 2B.

FIG. 2C is a close-up view of align and cure station 12. As shown, fixture 114 is linked to conical head 207 by an extendible tube 212, which includes a spring-loaded mechanism. Tube 212 is normally locked in the upper position but can be released by the operator. When released, a spring within tube 212 urges conical head 207 downward against disk 102 (see arrows 214) with a force that clamps disk 102 against a center post 205 but nonetheless allows disk 102 to be translated horizontally by micrometers 106, 108. Also shown in FIG. 2C is a hub member 104A that is positioned in the center hole of disk 102.

FIG. 2D shows a perspective view of conical head 207 from below, showing in particular a contact surface 209 that makes contact with disk 102 when head 207 is lowered. Head 207 has a threaded fitting (not shown) that can be unscrewed, allowing head 207 to be removed from align and cure station 12.

Head 207 is used during the alignment of the first hub member 104A on one side of disk 102. As described below, when disk 102 has data on both sides a second hub member can be attached to the opposite side of disk 102 and can be centered with respect to a data region on that side of the disk 102 independently of the first hub member 104A. When this is done, head 207 is removed from the tool and is replaced by a head 207A, shown in FIG. 2E. Head 207A has a contact surface 209A which is pressed against the first hub member during the alignment of the second hub member. Contact surface 209A contains four notches 209X, spaced at 90° intervals which, as described below, allow the UV light to reach the bonding surfaces of the second hub member.

FIG. 2F is a schematic top view of disk 102 and video cameras A, B and C. For the sake of clarity, micrometers 106 and 108 are omitted, and are represented by arrows T₁ and T₂, respectively. Spring stop 110 is also omitted and is represented by a force F_{c} against the edge of disk 102. The spindle on which hub member 104A is mounted is shown as 204.

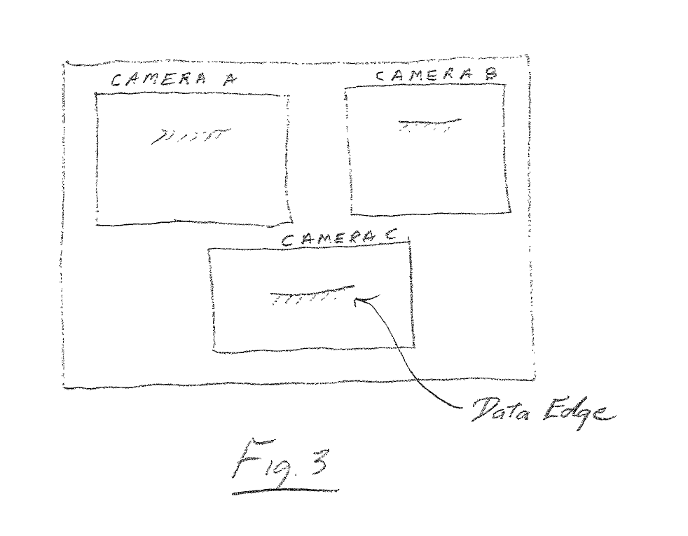

Also shown in FIG. 2F are mirrors 201, 202 and 203. Each of mirrors 201, 202 and 203 is mounted under edge of disk 102 at a 45° angle with respect to the surface of disk 102. Mirrors 201, 202 and 203 are positioned at 120° intervals around disk 102 such that the views recorded by video cameras A, B and C are as shown in FIG. 3, with a section of the circular data edge on the bottom side of the disk being visible. As described further below, the data edge is typically located at a boundary between a premastered area of the disk and a writeable area of the disk. As shown in FIG. 3, with an optical disk the premastered region typically appears lighter than the writeable area.

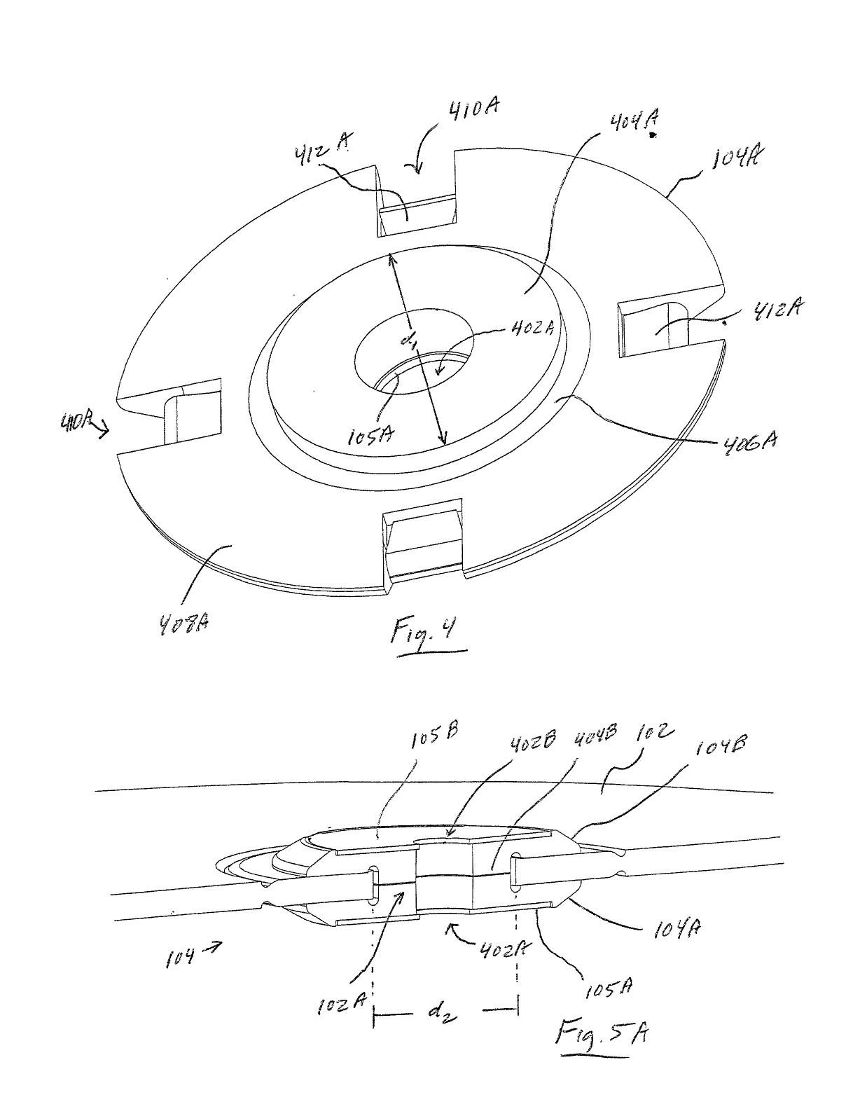

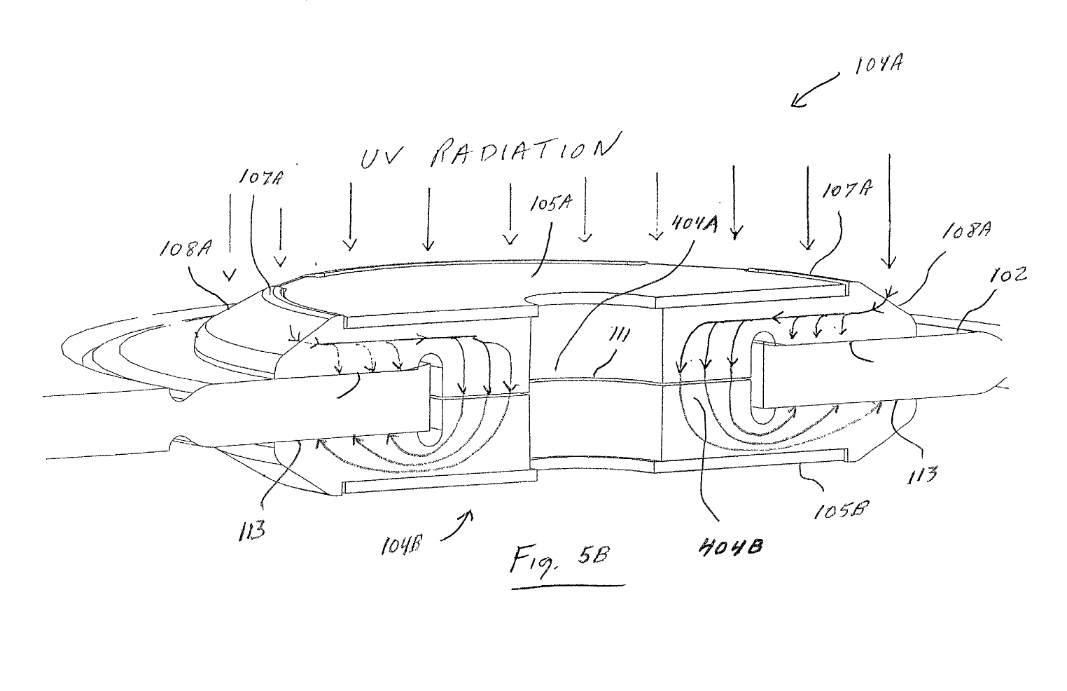

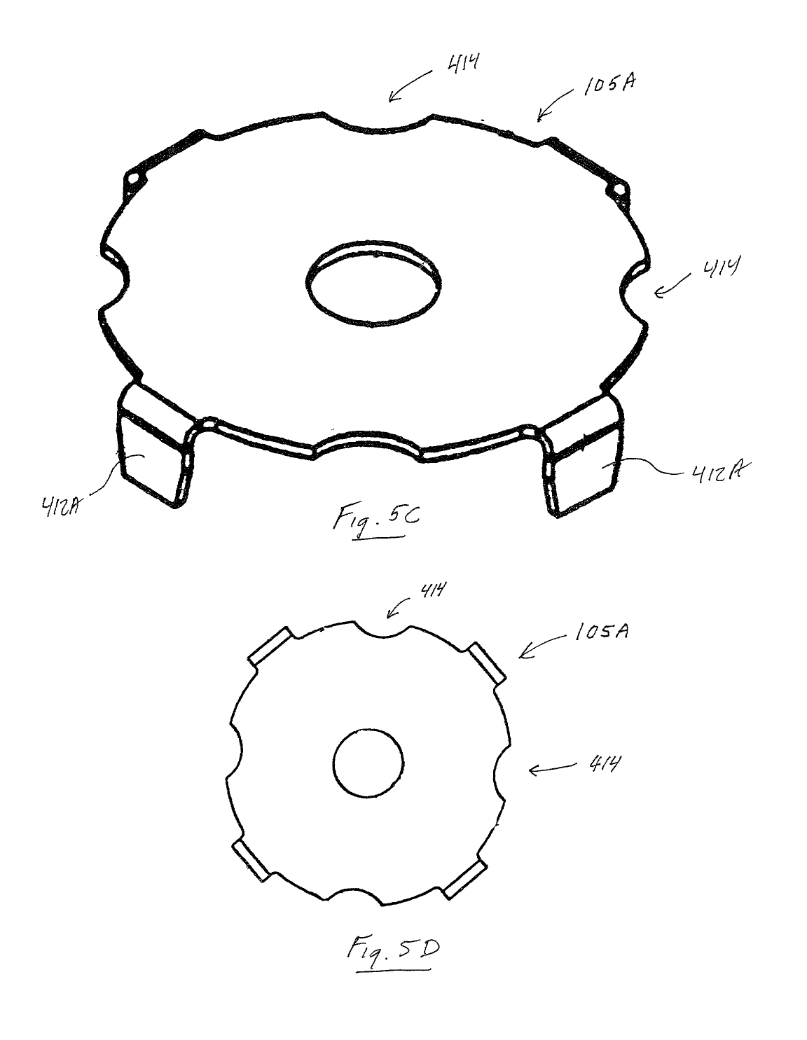

Hub member 104A is combined with another hub member 104B to form a hub 104. Two metal hub plates 105A and 105B are attached to hub members 104A and 104B, respectively, by means of tabs, as described in the above-referenced Application No. [Attorney Docket No. M-8729 US]. As shown in the detailed view of FIG. 5A, hub member 104A includes a metal hub plate 105A and fits against one side of disk 102, and hub member 104B includes a metal hub plate 105B and fits against the opposite side of disk 102. In this embodiment, except for metal hub plates 105A and 105B, hub members 104A and 104B are made of an optical grade, UV-transparent polycarbonate. FIG. 4 shows a detailed view of hub member 104A. Metal hub plate 105A has a center hole 402A, which in this embodiment is slightly smaller than the center hole of the plastic portion of hub member 104A, and which defines the axis of rotation of hub member 104A. Center hole 402A fits securely but rotatably over spindle 204 and, being metal, is less susceptible to wear than if the center hole of the plastic portion of hub member 104A were to contact spindle 204.

Radially outward from center hole 402A is a boss 404A, which is a raised area that fits into a center hole of disk 102. A groove 406A surrounds boss 404A, and a bonding surface 408A extends from groove 406A to the outside edge of hub member 104A. Hub member 104A is designed to be bonded to a disk in the area of surface 408A, and groove 406A is used to contain any overflow of adhesive. In this embodiment, four notches 410A are formed at equal intervals around the outside of hub member 104A. As described in the above-referenced Application No. [Attorney Docket No. M-8729 US], four tabs 412A of metal hub plate 105A are bent into notches 410A and contact between the side edges of tabs 412A and the side walls of notches 410A fixes the central axes of hub member 104A and metal hub plate 105A in relation to each other while permitting differential thermal expansion between the plastic portion of hub member 104A and metal hub plate 105A. In other embodiments, the notches and metal hub plate may be omitted.

FIG. 5A shows disk 102 gripped between hub plates 104A and 104B. As indicated, disk 102 has a center hole 102A into which the bosses 404A and 404B of hub members 104A and 104B are inserted. The diameter d, of bosses 404A and 404B (FIG. 4) is less than the diameter d₂ of the center hole 102A of disk 102 (FIG. 5A) by a predetermined margin. For example, if the diameter d₂ of the disk center hole is 4.0 mm, the diameter d₁ of the bosses could be 3.65 mm. Thus, as is evident from FIG. 5A, until disk 102 is bonded to hub members 104A, 104B, the clearance between the center hole of disk 102 and the bosses allows disk 102 to be translated with respect to hub members 104A and 104B. In addition, the height of the bosses 404A and 404B should be approximately equal to one-half the thickness of disk 102 and in one embodiment is equal to 0.287 mm.

Since the geometric centers of the data regions on the opposite sides of disk 102 do not necessarily coincide, the center holes 402A, 402B are aligned independently and are not necessarily coincident when disk 102 has been bonded to hub members 104A, 104B. Referring to FIG. 5A, hole 402A is aligned with the center of the data region on the bottom side of disk 102, and hole 402B is aligned with the center of the data region on the top side of disk 102.

Before alignment and bonding tool 10 can be used to align a disk with a hub, the tool must be calibrated. This essentially involves determining parameters which are representative of the “machine center”, i.e., the location of spindle 204, on which a hub will be positioned during the alignment process.

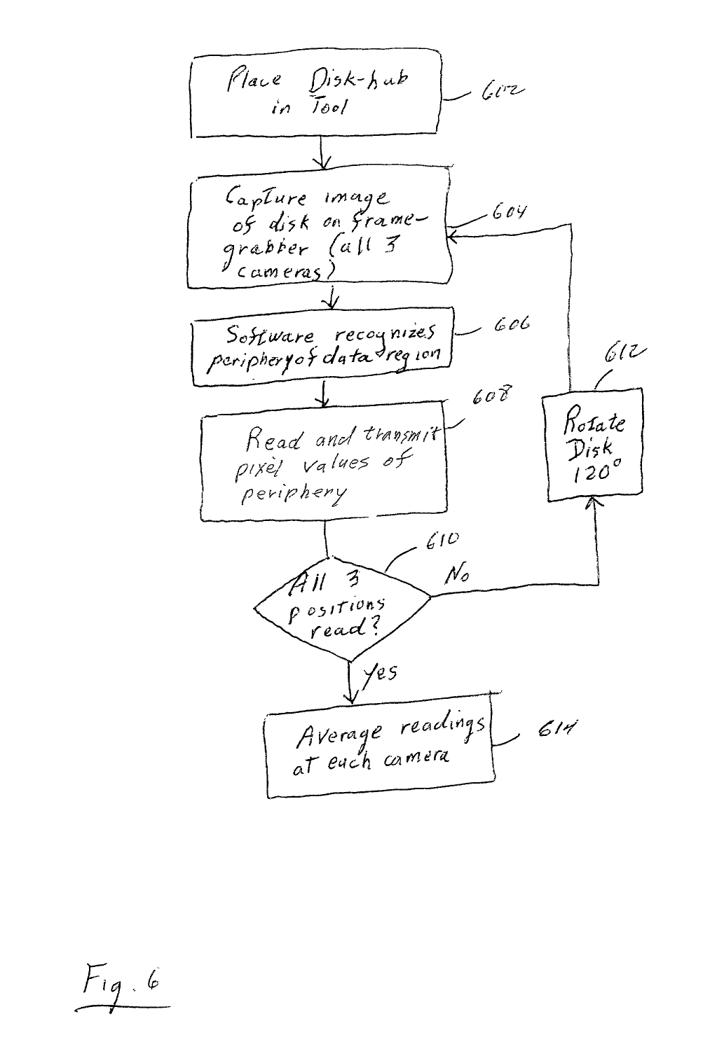

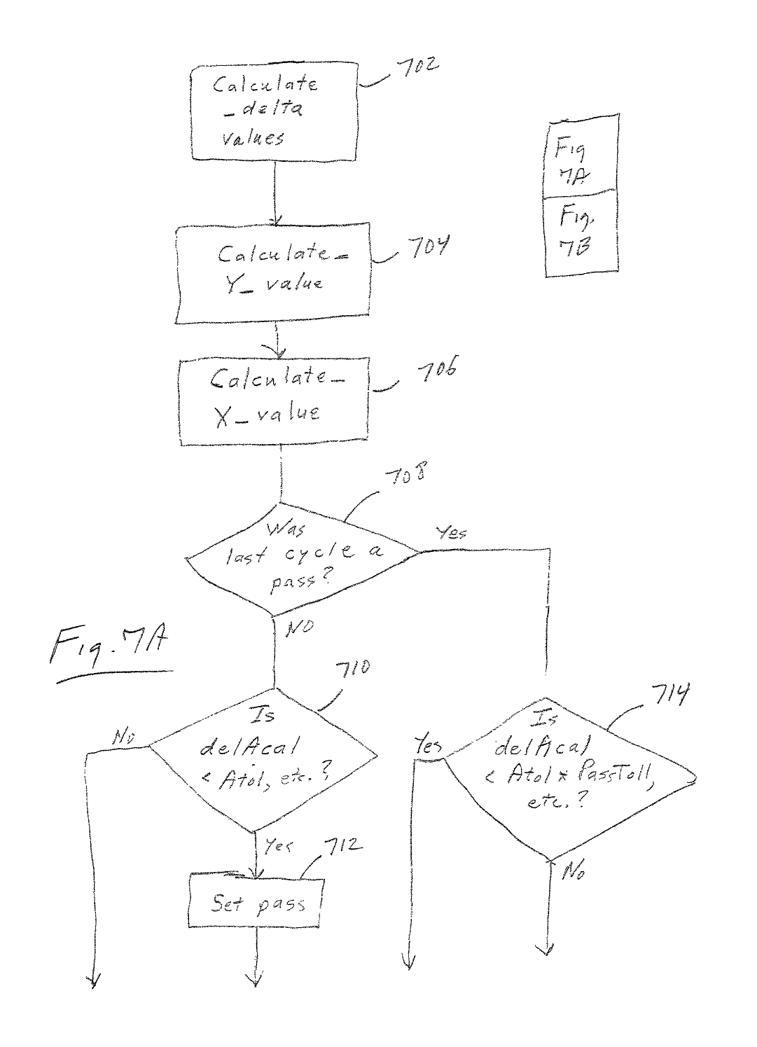

FIG. 6 shows a flow chart for a process of calibrating tool 10. For this purpose, a calibration disk is used. The calibration disk should be a disk that is representative of production disks, in terms of size, optical properties, etc., and it should be well-centered on a hub, preferably using the process described below. The calibration disk preferably has markings spaced at 120° about its axis of rotation. Initially, micrometers 106, 108 are backed-off just enough to allow the calibration disk to be mounted on spindle 204 (step 602). One of the markings is positioned at a reference point (e.g., next to the plunger of micrometer 108). The calibration disk is clamped to center post 205, on which spindle 204 is mounted, by lowering conical head 207 until it contacts the calibration disk (see FIG. 2C).

PC 14 is switched into a mode which allows the operator to view the edge of a data region of the calibration disk in the monitor 15 (step 604). FIG. 3 shows the monitor 15 with the view recorded by each of the cameras displayed. The edge of the data region is detected by edge detection software that includes an algorithm that detects the brightness of each pixel and identifies a transition from the data region, where the pixels are brighter, to a region of the disk adjacent the data region, where the pixels are darker (step 606). Such software is available from DVT Corporation.

The “edge” that is detected by the software (sometimes referred to herein as a “data edge”) is preferably an edge of a premastered (prerecorded) area of the disk. For example, if the disk is entirely premastered, the inside diameter of the premastered area could be used. If the disk is partially premastered and partially writeable, a boundary between the premastered and writeable areas could be used. If the disk is generally writeable, it will normally contain some premastered bands in which case an edge of a premastered band could be used.

Mirrors 210, 202, 203 are adjusted if necessary to ensure that the data edge is properly positioned in the view recorded by each camera. In this embodiment, PC 14 runs Visual BASIC, and each of cameras A, B and C transmits data packets representing the location of the data edge. The data packets are transmitted to PC 14 via an Ethernet link every 100 msec. Cameras A, B and C operate independently of the Visual BASIC program running in PC 14.

With the calibration disk clamped to center post 205, three data values (pixel numbers) D_{A1}, D_{B1} and D_{C1}, representing the location of the edge of the data region recorded by cameras A, B and C, respectively, are transmitted to PC 14. The data is received in PC 14 by three Ethernet data socket controls called SCKDVT1_DataArrival, SCKDVT2_DataArrival and SCKDVT3_DataArrival. The data packets are checked for valid numerical values and placed in working variables, displayA, displayB and display C.

Using the markings on the calibration disk, the disk is then manually rotated 120° about spindle 204 (step 612), and steps 604, 606 and 608 are repeated. The disk is then rotated 120° about spindle 204 a second time, and steps 604, 606 and 608 are repeated again.

When all three angular positions of the disk have been read (step 610), the readings for each camera are then averaged (step 614). For example, if the three readings for camera A are D_{A1}, D_{A2} and D_{A3}, the average reading, designated “permAcal”, is:

$$permAcal = \frac{{D}_{A1} + {D}_{A2} + {D}_{A3}}{3}$$

In the same way the average readings for cameras B and C are computed, yielding “permBcal” and “permCcal”. Since permAcal, permBcal and permCcal are averages of pixel numbers representing the location of the edge of the data region at 120° intervals, permAcal, permBcal and permCcal are pixel numbers that represent the location of the data edge when the geometric center of the data region is at the “machine center” of the tool, i.e., the location of spindle 204.

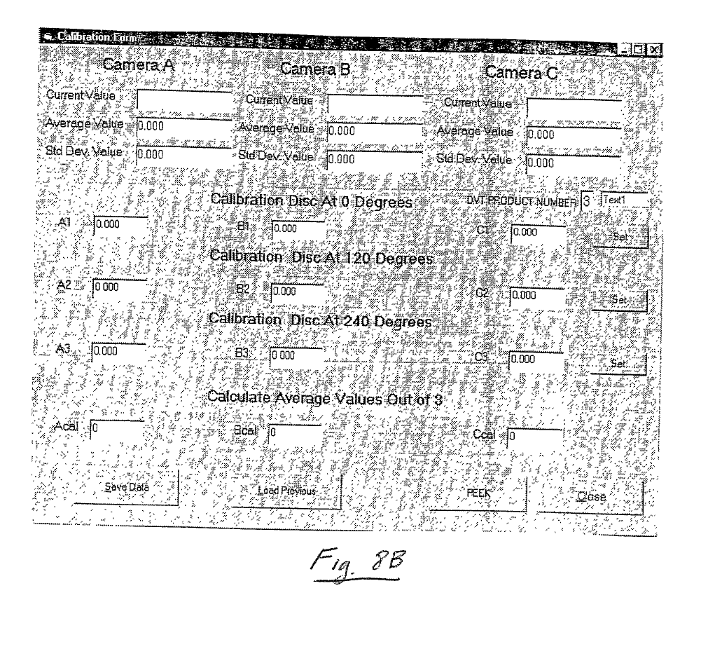

FIG. 8B shows the monitor during the calibration process. When the disk is at each position (0°, 120°, 240°) the Set button on the right is clicked to show the reading in each camera. The Average Values can be checked to insure a steady reading. When the third Set button is clicked the average values are automatically displayed at the bottom of the screen. At any time the Peek button can be clicked to confirm that there is a good image from each camera.

Once permAcal, permBcal and permCcal have been determined, tool 10 can be used to center a disk on a hub.

Initially, an operator assembles a hub member and a disk on the tool (step 702). For example, using a tweezers, hub member 104A is carefully placed on spindle 204 with metal hub plate 105A facing downward, i.e., oriented as shown in FIG. 4. Hub member 104A is held on spindle 204 by the attractive force between metal hub plate 105A (FIG. 5A) and two small magnets that are mounted within center post 205. Using adhesive dispense station 16, the operator manually delivers a predetermined quantity (e.g., 0.00107 ml) of a UV adhesive, such as Dymax 4-104A70, onto bonding surface 408A of hub member 104A. In one embodiment, adhesive is manually delivered to four locations on surface 408 using a 1500 Series EFD dispenser distributed by Dijac of Lakewood, Colo. Next, a disk 102 is removed from the holding tray where it is typically stored, using, for example, a vacuum wand, and placed on the bonding surface 408A, with the boss 404A protruding into the center hole 102A of the disk. Since the UV adhesive has not yet been cured, disk 102 is still movable with respect to hub member 104A. If the disk is single-sided, the data side is placed downward.

Fixture 114 is rotated to position the end of light pipe 116 (conical head 207) over hub member 104A. Tube 212 is twisted to release the spring mechanism inside, and conical head 207 is slowly lowered until head 207 makes contact with disk 102. Spring stop 110 is carefully pushed forward, pressing the edge of disk 102 against the plungers of micrometers 106, 108. Hub member 104A is now in a position where is can be centered with respect to the data region on disk 102 by adjusting micrometers 106, 108.

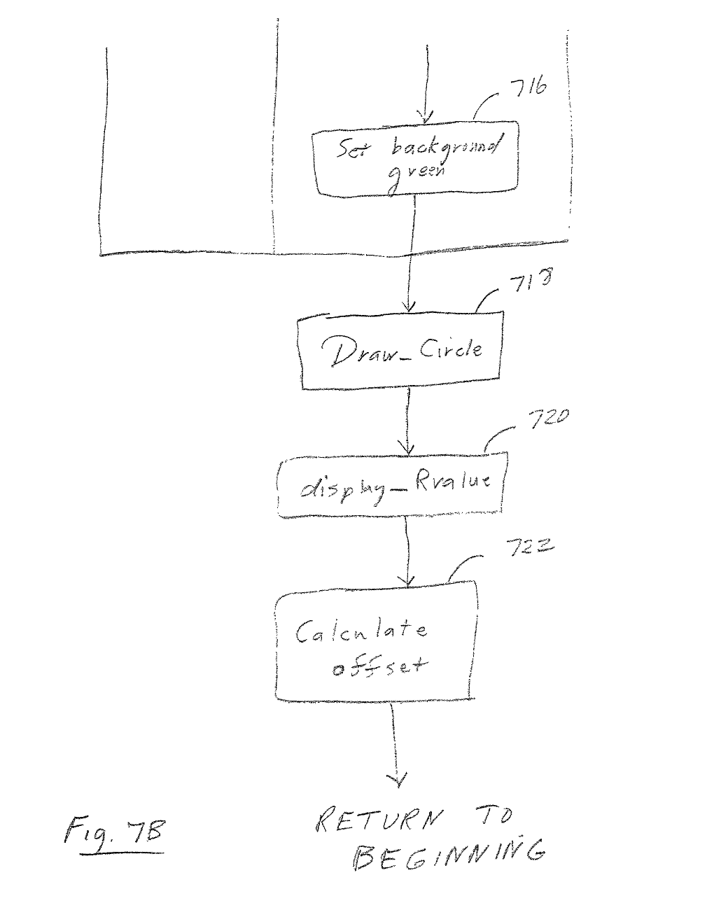

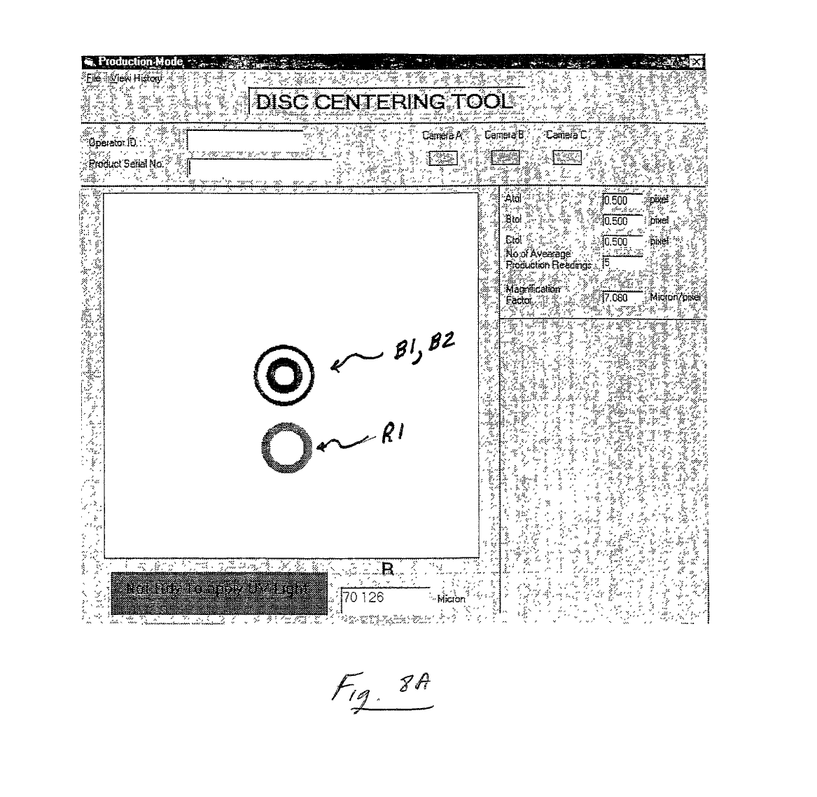

A process for centering the hub is summarized in the flow chart of FIGS. 7A and 7B. The Visual BASIC program running in PC 14 has a subroutine called Timer1_Timer which repeats every 100 msec and contains calls to several additional subroutines which perform the actual data processing and checking.

The first of these additional subroutines, called calculate_delta (step 702), calculates a delta value for each of cameras A, B and C using the following formulas:

delAcal=displayA−permAcal−offset

delBcal=displayB−permBcal−offset

delCcal=displayC−permCcal−offset

where displayA, displayB and displayC are the current pixel number readings provided by cameras A, B and C, respectively, and offset is a value calculated at the end of the previous cycle to compensate for variations in the size of the data region on the disk. Offset is initially set at zero. Since permAcal, permBcal and permCcal are pixel numbers that represent the location of the edge of the data region when the geometric center of the data region is at the location of spindle 204, delAcal, delBcal and delCcal are measures of the deviation of the center the data region from the center of hub member 104A.

After delAcal, delBcal and delCcal have been calculated, the subroutine Calculate_Y_value is run (step 704). This subroutine calculates the Y component of the distance between the hub center (spindle 204) and the current location of the geometric center of the data area of disk 102 (the “data center”), according to the following formula:

DisplayY=(delCcal−2*delBcal−2*delAcal)/3

The XY coordinate system is oriented as shown in FIG. 2C, with the Y-axis coincident with the axis of camera C

The next subroutine, called Calculate_X_value (step 706), calculates the X component of the distance between the hub center (spindle 204) and the current location of the data center, according to the following formula:

DisplayX=[(2*delBcal/−sqrt3)+(2*delAcal/sqrt3)]/2

This is followed by a subroutine called Check_Pass_Fail. Check_Pass_Fail determines whether the current readings delAcal, delBcal and delCcal are greater than predetermined tolerance values Atol, Btol and Ctol, respectively (step 710). In one embodiment, Atol, Btol and Ctol are set to one-half the width of a pixel, or 3.4 microns. If delAcal, delBcal and delCcal are less that the previously established tolerances Atol, Btol and Ctol, respectively, the program sets a Pass condition (step 712).

Because it normally takes some time for the operator adjusting the position of the disk 102, using micrometers 106 and 108, to react to a Pass condition, the program determines whether tolerance criteria are satisfied on two successive cycles. Thus if a Pass condition is set as described above on the previous cycle, the program determines whether delAcal, delBcal and delCcal are still within predetermined “relaxed” tolerances during the present cycle. Thus, if a Pass condition was set during the last cycle (step 708), the program determines if delAcal, delBcal and delCcal meet a tolerance equal to Atol, Btol and Ctol, respectively, times a factor called PassTol (step 714). In the embodiment described above, PassTol is equal to two, and thus the product of each of the values, Atol, Btol and Ctol, and PassTol is equal to 6.8 microns.

If this second tolerance test is satisfied, the background of monitor 15 changes from white to green (step 716), indicating that the data center is within the required distance of the hub center (spindle 204).

The next subroutine is called Draw_Circle (step 718). Draw_Circle causes monitor 15 to display the calculated data center as a red circle and the hub center as a pair of blue circles, thus showing graphically the relationship between the center of the data region and the hub center. If X or Y are out of a predetermined rectangular area of the display, the red circle is positioned at the edge of the rectangular area. The background color is white until, as described above, the data center is within the required distance of the hub center, at which it is converted to green.

FIG. 8A illustrates the display during the above process, showing the red circle R1 and the pair of blue circles B1, B2. The data region is properly centered when the red circle R1 is positioned concentrically between the blue circles B1, B2.

The subroutine display_Rvalue is now called (step 720). The radial distance (R) between the data center and the hub center is calculated, using the formula:

R=sqrt[(displayX*displayX)+(displayY*displayY)]*magnification factor

where the magnification factor is the amount that actual distances are magnified in the data transmitted by cameras A, B and C. The program averages the values of R during five consecutive cycles of the program (the present cycle and four previous cycles) and displays the average on the monitor. The value of R is displayed in the area designated “R” in FIG. 8A.

In the last subroutine Timer1_Timer (step 722), the next offset value is calculated according to the following formula:

offset=[(displayA+displayB+displayC)/3]−[permAcal+permBcal+permCcal)/3]

Until disk 102 is adequately centered on hub member 104A, the operator continues to use micrometers 106, 108 to readjust the position of the disk 102. When the disk is centered within the specification that has been established, the operator turns on the UV source 1 16 for a predetermined time period of time (e.g., 5 seconds) to cure the UV adhesive and bond the disk 102 to hub member 104A. Since disk 102 is typically transparent to UV radiation, the radiation can reach the UV adhesive at the interface between bonding surface 408A and disk 102.

When disk 102 has been centered on hub member 104A to the required specification and the bonding has been completed, head 207 is lifted to its locked upper position and spring stop 110 is pushed away from disk 102. The assembly of disk 102 and hub member 104A is removed from align and cure station 12 and stored temporarily in a holding tray in one of the staging areas 18, 20.

The second hub member 104B is then placed on spindle 204, with metal plate 105B facing downward. UV adhesive is applied to a bonding surface 408B (similar to bonding surface 408A of hub member 104A) and boss 404B of hub member 104B, and the assembly of disk 102 hub member 104A is placed on top of hub member 104B. The length of spindle 204 is such that spindle 204 does not protrude into the center hole of hub member 104A (i.e., the center hole 402A of metal hub plate 105A). Thus, hub member 104B can be aligned with a data region on the bottom side of disk 102 independently of hub member 104A.

Head 207 is now replaced with head 207A (FIG. 2E), and spring stop 110 is carefully pushed forward, pressing the edge of disk 102 against the contact surfaces of micrometers 106, 108. The spring mechanism within tube 212 is released downward, pressing head 207A against hub member 104A.

The relative positions of hub members 104A and 104B and disk 102 at this juncture are shown in FIG. 5B. As shown, boss 404A of hub plate 104A is in contact with boss 404B of hub member 104B at an interface 111 within the center hole of disk 102. Note that the diameter of the bosses 408A, 408B are slightly less than the inside diameter of the center hole of disk 102, which allows each hub member to be positioned independently at the geometric center of the data region on one side of the disk.

The process outlined in FIGS. 7A and 7B is then repeated until the data region on the bottom side of disk 102 is centered on hub member 104B to the required specification.

Disk 102 is then bonded to hub member 104B in the following manner. With head 207A lowered against hub member 104A, contact surface 209A (FIG. 2E) presses against a rim 107A of hub member 104A. As shown in FIG. 5B, rim 107A surrounds metal hub plate 105A and is raised slightly with respect to the surface of metal hub plate 105A. Notches 209X of head 207A (FIG. 2E) extend radially outward, over an annular slanted surface 108A of hub member 104A. As described above, hub members 104A, 104B are preferably formed of a UV-transmissive material such as optical grade polycarbonate. This causes hub members 104A, 104B to function as light pipes when exposed to UV radiation. In one embodiment, notches 209X are aligned with corresponding notches 414 in metal hub plate 105A, shown in FIGS. 5C and 5D and described in the above-referenced Application No. [Attorney Docket No. 8778-1P], to maximize the amount of UV radiation that enters hub member 104A.

Thus, as shown by the arrows in FIG. 5B, when head 207A is lowered against hub member 104A, the UV radiation from light pipe 116 enters the hub member 104A through notches 209X and slanted surfaces 108A. The UV light is then reflected from the surfaces of the hub members 104A, 104B and dispersed within the hub members 104A, 104B until it reaches the interface 111 between hub members 104A, 104B and an interface 113 between hub member 104B and disk 102, where it cures the UV adhesive. Thus, bonds are created between hub members 104A, 104B at interface 111 and between hub member 104B and disk 102 at interface 113. Permitting hub members 104A, 104B to be bonded to each other at interface 111 creates a much stronger bond between the hub assemblies and the disk than if the hub members were only bonded to the disk.

As stated above, after the disk and hub have been assembled, the holes 402A, 402B of hub 104 are not necessarily coaxial. When data is read from disk 102, the spindle of the disk drive extends only into the center hole 402A, 402B that is on the same side of disk as the data to be read. As a result, the data region that is read is properly centered on the spindle of the disk drive.

The particular embodiment of the method described above is illustrative only, and not limiting. For example, while three video cameras are used in the embodiment described, either two or more than three cameras may be used in other embodiments. In addition, cameras other than video cameras can be used. Different mathematical formulas may be used to calculate the location of the data center and to determine if the data center is within a required distance of the hub (machine) center. For example, the value of R may be compared against a predetermined tolerance for the distance between the data center and the hub center.

Moreover, materials other than UV adhesive may be used to bond the hub to the disk. For example, solvent-based welding, epoxy, methacrylic esters, pressure-sensitive adhesives, or ultrasonic bonding could be used to bond the disk to the hub members. In some embodiments, the hub may initially have no central hole, and a central hole may be bored in the hub after the data region of the disk has be aligned to the machine center. While in the embodiment described there are two hub members which attach to opposite sides of the disk, in other embodiments there may be only one “hub member” that attaches to the disk. In some cases, the “hub member” may be the “hub”. Some or all of the steps described above as being performed by a human operator may be automated.

Many such variations and modifications in accordance with the invention will be evident to those of skill in the art.

We claim:

1. A method of aligning a data storage disk with respect to a hub member using a hub centering machine, the hub centering machine comprising a plurality of video cameras positioned around a machine center, the method comprising:
placing the hub member at the machine center;
placing the disk adjacent to the hub member, the disk including a data region and a data edge;
recording a view of the data edge in each of the video cameras;
calculating a delta distance representative of a distance between a calibration value and a location of the data edge in the view recorded in each video camera;
adjusting the position of the disk in relation to the hub member;
recalculating the delta distance recorded by each video camera;
determining whether the delta distance recorded by each video camera is less than a preselected tolerance value; and
bonding the disk to the hub member.

2. The method of claim 1 comprising determining whether the delta distance recorded by each video camera is less than a second preselected tolerance value, the second preselected tolerance value being greater that the preselected tolerance value.

3. The method of claim 2 wherein the second preselected tolerance value is equal to the preselected tolerance value multiplied by a factor greater than one.

4. The method of claim 3 wherein bonding the disk to the hub member occurs after determining whether the delta distance recorded by each video camera is less than a second preselected tolerance value.

5. The method of claim 1 wherein calculating a delta distance comprises:
determining an offset representing a size of the data region;
subtracting the offset and the calibration value from the location of the edge of the data region in the view recorded in each camera.

6. The method of claim 5 wherein, after the delta distance is calculated a first time, determining the offset comprises applying the following formula:
offset−[(displayA+displayB+ . . . displayN)/N]−[permAcal+permBcal+ . . . permNcal)/N]
wherein N equals the number of video cameras; displayA through displayN equal a location of the edge of the data region in the view recorded in each video camera, respectively; and permAcal through permNcal equal the calibration values for the video cameras, respectively.

7. The method of claim 6 wherein the offset is set at zero the first time the delta distance is calculated.

8. The method of claim 1 comprises calculating a location of the center of the data region in an XY coordinate system.

9. The method of claim 8 wherein calculating a location of the center of the data region in an XY coordinate system comprises applying the following formula:
displayX=[(2*delBcal/−sqrt3)+(2*delAcal/sqrt3)]/2
wherein displayX is an X coordinate of the center of the data region in the XY coordinate system, delAcal is a delta distance recorded by a first one of the video cameras, and delBcal is a delta distance recorded by a second one of the video cameras.

10. The method of claim 8 wherein calculating a location of the center of the data region in an XY coordinate system comprises applying the following formula:
displayY=(delCcal−2*delBcal−2*delAcal)/3
wherein displayY is a Y coordinate of the center of the data region in the XY coordinate system, delAcal is a delta distance recorded by a first one of the cameras, and delBcal is a delta distance recorded by a second one of the cameras.

11. The method of claim 8 comprising calculating the distance between the center of the data region and the machine center according to the formula:
R=sqrt[(displayX*displayX)+(displayY*displayY)]*magnification factor
wherein R is the distance between the center of the data region and the machine center, displayX is an X coordinate of the center of the data region in the XY coordinate system, displayY is a Y coordinate of the center of the data region in the XY coordinate system, and magnification factor is the amount that actual distances are magnified in the data transmitted by the video cameras.

12. The method of claim 11 wherein magnification factor is expressed as a number of pixels per unit distance.

13. The method of claim 11 comprising averaging a predetermined number of values of R as the position of the disk is adjusted in relation to the hub member.

14. The method of claim 11 comprising displaying on a screen a first object representing a location of a center of the hub member and a second object representing the center of the data region.

15. The method of claim 14 wherein displaying on a screen a second object representing the center of the data region comprises displaying a pair of concentric circles.

16. The method of claim 15 wherein displaying on a screen a first object representing a location of a center of the hub member comprises displaying a single circle having an outer diameter less than an inner diameter of a larger one of said pair of concentric circles and an inner diameter greater than an outer diameter of a smaller one of said pair of concentric circles.

17. The method of claim 1 comprising applying an adhesive at an interface between the hub member and the disk.

18. The method of claim 17 wherein applying an adhesive comprises applying a UV-curable adhesive.

19. The method of claim 18 wherein bonding the disk to the hub member comprises applying UV radiation to the adhesive.

20. A method of calibrating a hub centering machine, the hub centering machine comprising a plurality of video cameras positioned around a machine center, the method being for determining a calibration value for each of the cameras, the method comprising:
positioning a calibration disk such that a center of the calibration disk coincides with the machine center, the disk including a data region and a data edge;
recording a view of the data edge in each of the video cameras;
determining a first location of the data edge in each of the video cameras;
rotating the calibration disk a predetermined angle about the machine center;
determining a second location of the data edge in each of the video cameras;
averaging the locations of the data edge for each of the video cameras, thereby to determine a calibration value for each of the video cameras.

21. The method of claim 20 comprising;
rotating the calibration disk a second time said predetermined angle about the machine center, wherein said predetermined angle is 120 degrees; and
determining a third location of the data edge for each of the video cameras.

22. The method of claim 1 comprising using the method of claim 20 to determine a calibration value of each of the video cameras.

23. A machine for aligning a data storage disk with respect to a hub member such that a geometric center of a data region on the disk coincides with an axis of rotation of the hub member, the machine comprising:
a plurality of video cameras positioned around a machine center, the video cameras being aligned such that each video camera is capable of recording a data edge on the disk;
a structure for fixing a center of a hub member at the machine center;
a mechanism for adjusting the position of a disk relative to the hub member.

24. The machine of claim 23 wherein the structure for fixing a center of a hub member at the machine center comprises a spindle.

25. The machine of claim 23 wherein the mechanism for adjusting the position of a disk relative to the hub member comprises a plurality of micrometers.

26. The machine of claim 25 comprising a spring-loaded device for urging a disk against the micrometers.

27. The machine of claim 23 comprising a PC and a monitor.

28. The machine of claim 23 comprising an adhesive dispensing unit.

29. The machine of claim 28 comprising a source of UV radiation.

30. The machine of claim 29 comprising a light pipe for transmitting UV radiation from the source of UV radiation to the machine center.

31. The machine of claim 30 comprising a fixture for pressing a disk against a hub member.

32. The machine of claim 31 wherein the light pipe is connected to the fixture.

33. The machine of claim 32 wherein the fixture comprises a central opening and a plurality of notches around a periphery of the opening to facilitate the delivery of UV radiation from the fixture.
